(19) United States
(12) Patent Application Publication
(10) Pub. No.: US 2012/0176009 A1
(43) Pub. Date: Jul. 12, 2012

(54) Fixing Structure for Thin Housings and Electronic Apparatus Comprising Fixing Structure for Thin Housings

(75) Inventors: Mari MUROI, Daito-shi (JP); Hideki Kume, Daito-shi (JP)

(73) Assignee: Funai Electric Co., Ltd., Daito-shi (JP)

(21) Appl. No.: 13/345,039

(22) Filed: Jan. 6, 2012

(30) Foreign Application Priority Data
Jan. 7, 2011 (JP) 2011-1810

(51) Int. Cl. H02B 1/26; A47B 81/00

(52) U.S. Cl. 312/223.1; 312/352

(57) ABSTRACT

This fixing structure for thin housings is so formed as to disengage an engaging projecting portion and an engaging recess portion from each other by moving an intersection between a first inclined portion and an end section along the first inclined portion while deflecting at least either the engaging projecting portion or the engaging recess portion when disengaging the engaging projecting portion and the engaging recess portion from each other.

### BACKGROUND OF THE INVENTION

1. Field of the Invention

The present invention relates to a fixing structure for thin housings and an electronic apparatus comprising a fixing structure for thin housings, and more particularly, it relates to a fixing structure for thin housings and an electronic apparatus comprising a fixing structure for thin housings each including an engaging projecting portion and an engaging recess portion.

2. Description of the Background Art

In general, a fixing structure for thin housings including an engaging projecting portion and an engaging recess portion is disclosed in Japanese Patent Laying-Open No. 2000-77870, for example.

The aforementioned Japanese Patent Laying-Open No. 2000-77870 discloses a locking hook for fixing a locked member (engaging recess portion) of a flat plate type printed board or case lid portion to a prescribed position in an electronic apparatus. This locking hook includes a straight portion substantially linearly extending upward and a hook portion (engaging projecting portion) provided on the forward end of the straight portion. The hook portion has an inclined surface (sliding surface) inclined downward at a prescribed angle with respect to the extensional direction of the straight portion and a planar engaging surface (engaging surface rectangular in plan view) extending in a direction substantially orthogonal to the extensional direction of the straight portion. In order to fix the locked member and the hook portion to each other (to mount the former on the latter) in the aforementioned Japanese Patent Laying-Open No. 2000-77870, the locked member is brought into contact with the inclined surface of the hook portion and pushed downward (in a mounting direction), so that the upper surface of the locked member engages with the engaging surface of the hook portion. Thus, the upper surface of the locked member and the engaging surface of the hook portion engage with each other, to have rectangular engaging regions (engaging surfaces) in plan view.

In the aforementioned Japanese Patent Laying-Open No. 2000-77870, the locked member is mounted along the inclined surface of the hook portion when fixed to (mounted on) the hook portion, whereby the hook portion and the locked member can easily engage with each other. When the locked member and the hook portion are disassembled (when the former is detached from the latter), however, the locked member is caught by the hook portion if force is applied in a direction (disassembling direction) opposite to the direction for mounting the locked member on the hook portion, and hence the force applied in the disassembling direction disadvantageously concentrates on the rectangular engaging regions (engaging surfaces) of the upper surface of the locked member and the engaging surface of the hook portion. Consequently, the hook portion is disadvantageously broken.

### SUMMARY OF THE INVENTION

The present invention has been proposed in order to solve the aforementioned problem, and an object of the present invention is to provide a fixing structure for thin housings and an electronic apparatus comprising a fixing structure for thin housings, each capable of preventing an engaging projecting portion from breakage when disassembling an engaging hook (engaging projecting portion) and a locked member (engaging recess portion) of thin housings.

A fixing structure for thin housings according to a first aspect of the present invention includes a thin first housing including at least either an engaging projecting portion or an engaging recess portion and a thin second housing including at least either the engaging recess portion or the engaging projecting portion engaging with at least either the engaging projecting portion or the engaging recess portion of the first housing, an engaging surface of either the engaging projecting portion or the engaging recess portion is provided with a first inclined portion inclined while intersecting with an end section of an engaging surface of either the engaging recess portion or the engaging projecting portion over a region from the vicinity of a first end up to the vicinity of a second end in a direction substantially orthogonal to an engaging direction of the engaging projecting portion and the engaging recess portion as viewed from the engaging direction, and the fixing structure for thin housings is so formed as to disengage the engaging projecting portion and the engaging recess portion from each other by moving an intersection between the first inclined portion and the end section along the first inclined portion while deflecting at least either the engaging projecting portion or the engaging recess portion when disengaging the engaging projecting portion and the engaging recess portion from each other.

As hereinabove described, the fixing structure for thin housings according to the first aspect is so formed as to disengage the engaging projecting portion and the engaging recess portion from each other by moving the intersection between the first inclined portion and the end section along the first inclined portion while deflecting at least either the engaging projecting portion or the engaging recess portion when disengaging the engaging projecting portion and the engaging recess portion from each other. Thus, the fixing structure disengages the engaging projecting portion and the engaging recess portion from each other while moving the intersection between the first inclined portion and the end section along the first inclined portion when disengaging the engaging projecting portion and the engaging recess portion from each other (disassembling the engaging projecting portion and the engaging recess portion), whereby the engaging recess portion can be prevented from catching the engaging projecting portion. Consequently, force applied in a disassembling direction can be inhibited from concentrating on engaging surfaces of the engaging projecting portion and the engaging recess portion, whereby the engaging projecting portion can be prevented from breakage when the engaging projecting portion and the engaging recess portion of the thin housings are disassembled.

In the aforementioned fixing structure for thin housings according to the first aspect, the engaging projecting portion and the engaging recess portion are preferably arranged to come into contact with each other on a side closer to the first end of the first inclined portion than the intersection between the first inclined portion and the end section while the engaging projecting portion and the engaging recess portion are arranged not to come into contact with each other on a side closer to the second end of the first inclined portion than the intersection between the first inclined portion and the end section in a state where the engaging projecting portion and the engaging recess portion engage with each other. According to this structure, retention (engaging state) of the engaging projecting portion and the engaging recess portion can be maintained in the region where the engaging projecting portion and the engaging recess portion are in contact with each other in the state where the engaging projecting portion and the engaging recess portion engage with each other. Further, the engaging projecting portion and the engaging recess portion can be disengaged from each other without applying strong force to the engaging projecting portion and the engaging recess portion from the region, serving as a starting point, where the engaging projecting portion and the engaging recess portion are not in contact with each other.

In this case, the fixing structure for thin housings is preferably so formed as to disengage the engaging projecting portion and the engaging recess portion from each other by moving the intersection between the first inclined portion and the end section from the side closer to the second end of the first inclined portion along the side closer to the first end while deflecting at least either the engaging projecting portion or the engaging recess portion when disengaging the engaging projecting portion and the engaging recess portion from each other. According to this structure, the engaging projecting portion and the engaging recess portion can be easily disengaged from each other by moving the intersection between the first inclined portion and the end section from the side closer to the second end of the first inclined portion along the side closer to the first end when disengaging the engaging projecting portion and the engaging recess portion from each other (disassembling the engaging projecting portion and the engaging recess portion).

In the aforementioned fixing structure for thin housings according to the first aspect, either the engaging projecting portion or the engaging recess portion is preferably provided with a second inclined portion inclined with respect to the engaging direction for facilitating engagement of the engaging projecting portion and the engaging recess portion, and the fixing structure for thin housings is preferably so formed that the angle of inclination of the first inclined portion of the engaging surface of either the engaging projecting portion or the engaging recess portion is smaller than the angle of inclination of the second inclined portion. According to this structure, the intersection between the first inclined portion and the end section can be rendered easily movable along the first inclined portion when disengaging the engaging projecting portion and the engaging recess portion from each other due to the relatively small (loose) angle of inclination of the first inclined portion as compared with a case where the fixing structure for thin housings is so formed that the angle of inclination of the first inclined portion is larger than the angle of inclination of the second inclined portion, whereby the engaging projecting portion and the engaging recess portion can be easily disengaged from each other.

In this case, either the engaging recess portion or the engaging projecting portion is preferably provided with a third inclined portion coming into contact with the second inclined portion formed on either the engaging projecting portion or the engaging recess portion when the engaging projecting portion and the engaging recess portion engage with each other. According to this structure, the engaging projecting portion and the engaging recess portion can be smoothly moved along the second and third inclined portions when engaging with each other, whereby the engaging projecting portion and the engaging recess portion can easily engage with each other.

In the aforementioned structure including the second inclined portion, the fixing structure for thin housings is preferably so formed that the width of the engaging surface of either the engaging projecting portion or the engaging recess portion in the extensional direction of the first inclined portion is larger than the width in the extensional direction of the second inclined portion. According to this structure, the angle of inclination of the first inclined portion can be easily rendered relatively small due to the relatively large width of the engaging surface in the extensional direction of the first inclined portion as compared with a case where the fixing structure for thin housings is so formed that the width of the engaging surface of either the engaging projecting portion or the engaging recess portion in the extensional direction of the first inclined portion is smaller than the width in the extensional direction of the second inclined portion.

The aforementioned fixing structure for thin housings according to the first aspect is preferably so formed that the width of the engaging surface of either the engaging projecting portion or the engaging recess portion in the extensional direction of the first inclined portion is smaller than the width of the engaging surface of either the engaging recess portion or the engaging projecting portion in a direction along the extensional direction of the first inclined portion. According to this structure, the engaging projecting portion and the engaging recess portion can easily engage with each other due to the small width of the engaging surface of either the engaging projecting portion or the engaging recess portion in the extensional direction of the first inclined portion, when the engaging projecting portion and the engaging recess portion engage with each other.

The aforementioned fixing structure for thin housings according to the first aspect is preferably so formed that the width of the engaging surface of either the engaging projecting portion or the engaging recess portion in the extensional direction of the first inclined portion is larger than the width of the engaging projecting portion or the engaging recess portion in a direction along the engaging direction. According to this structure, the sizes of engaging portions (regions) are increased due to the large width of the engaging surface of either the engaging projecting portion or the engaging recess portion in the extensional direction of the first inclined portion, whereby the engaging projecting portion and the engaging recess portion can reliably engage with each other.

In the aforementioned fixing structure for thin housings according to the first aspect, a clearance is preferably formed between the second end of the first inclined portion and the end section of the engaging surface of either the engaging recess portion or the engaging projecting portion as viewed from the engaging direction in a state where the engaging projecting portion and the engaging recess portion engage with each other. According to this structure, the first inclined portion can be rendered easily deflectable when force is applied in a direction for disengaging the engaging projecting portion and the engaging recess portion from each other dissimilarly to a case where no clearance is formed between the second end of the first inclined portion and the end section of the engaging surface of either the engaging recess portion or the engaging projecting portion, whereby the engaging projecting portion and the engaging recess portion can be more easily disengaged from each other.

In the aforementioned fixing structure for thin housings according to the first aspect, a plurality of at least either the engaging projecting portions or the engaging recess portions are preferably formed along the outer periphery of the first housing, a plurality of at least either the engaging recess portions or the engaging projecting portions are preferably formed along the outer periphery of the second housing, and the fixing structure for thin housings is preferably so formed that directions of inclination of the first inclined portions of the engaging surfaces of either the plurality of engaging projecting portions or the plurality of engaging recess portions are unified along a direction for successively detaching the first housing and the second housing from each other from a position serving as a starting point for disengaging the engaging projecting portions and the engaging recess portions from each other. According to this structure, the engaging projecting portions and the engaging recess portions can be successively continuously smoothly disengaged from each other from the position serving as the starting point for disengaging the engaging projecting portions and the engaging recess portions from each other along a direction for detaching the first housing and the second housing from each other when force is applied (the first housing and the second housing are pulled) in the direction for detaching the first housing and the second housing from each other.

In this case, the second ends of the first inclined portions of the engaging surfaces of either the engaging projecting portions or the engaging recess portions are preferably arranged on a side closer to the position serving as the starting point for disengaging the engaging projecting portions and the engaging recess portions from each other while the first ends of the first inclined portions are preferably arranged on a side closer to a forward end in the direction for successively detaching the first housing and the second housing from each other. According to this structure, the second ends of the first inclined portions arranged on the side closer to the position serving as the starting point for disengaging the engaging projecting portions and the engaging recess portions from each other can be easily detached from the end sections of the engaging recess portions when force is applied (the first housing and the second housing are pulled) in the direction for detaching the first housing and the second housing from each other.

In the aforementioned fixing structure for thin housings according to the first aspect, the shape of the first inclined portion of either the engaging projecting portion or the engaging recess portion preferably includes a linear shape or a curved shape. According to this structure, the intersection between the first inclined portion and the end section can be smoothly moved along the linear or curved first inclined portion when disengaging the engaging projecting portion and the engaging recess portion from each other, whereby the engaging projecting portion and the engaging recess portion can be easily disengaged from each other.

In the aforementioned fixing structure for thin housings according to the first aspect, the first inclined portion is preferably formed on the engaging surface of the engaging projecting portion, and so formed as to linearly extend at a substantially constant angle of inclination from the vicinity of the first end to the vicinity of the second end in the direction substantially orthogonal to the engaging direction of the engaging projecting portion and the engaging recess portion as viewed from the engaging direction and as to intersect with the end section of the engaging surface of the engaging recess portion, and the fixing structure for thin housings is preferably so formed as to disengage the engaging projecting portion and the engaging recess portion from each other by moving the intersection between the linear first inclined portion and the end section along the first inclined portion while deflecting at least either the engaging projecting portion or the engaging recess portion when disengaging the engaging projecting portion and the engaging recess portion from each other. According to this structure, the fixing structure disengages the engaging projecting portion and the engaging recess portion from each other while moving the intersection between the linear first inclined portion and the end section along the linear first inclined portion when disengaging the engaging projecting portion and the engaging recess portion from each other (disassembling the engaging projecting portion and the engaging recess portion), whereby the engaging recess portion can be prevented from catching the engaging projecting portion. Consequently, force applied in the disassembling direction can be inhibited from concentrating on the engaging surfaces of the engaging projecting portion and the engaging recess portion.

In this case, the engaging projecting portion preferably further includes a side section arranged on the side closer to the first end of the first inclined portion and arranged to be substantially orthogonal to the end section of the engaging surface of the engaging recess portion, and the engaging projecting portion preferably has a triangular shape protruding toward the engaging recess portion as viewed from the engaging direction due to the first inclined portion and the side section. According to this structure, the engaging projecting portion and the engaging recess portion can be disengaged from each other by moving the intersection between the first inclined portion and the end section along the first inclined portion through the first inclined portion while regulating movement of the engaging projecting portion and the engaging recess portion in the extensional direction of the first inclined portion through the side section of the engaging projecting portion.

In the aforementioned structure including the engaging projecting portion including the first inclined portion and the side section, the engaging projecting portion preferably has a top portion in the form of a substantially planar surface connecting the side closer to the first end of the first inclined portion and a side of the side section closer to the engaging recess portion as viewed from the engaging direction of the engaging projecting portion and the engaging recess portion. According to this structure, the quantity of protrusion of the engaging projecting portion can be reduced dissimilarly to a case where the engaging projecting portion has a sharp top portion, whereby the engaging projecting portion and the engaging recess portion can be easily disengaged from each other.

An electronic apparatus comprising a fixing structure for thin housings according to a second aspect of the present invention is an electronic apparatus comprising a fixing structure for thin housings, while the fixing structure for thin housings includes a thin first housing including at least either an engaging projecting portion or an engaging recess portion and a thin second housing including at least either the engaging recess portion or the engaging projecting portion engaging with at least either the engaging projecting portion or the engaging recess portion of the first housing, an engaging surface of either the engaging projecting portion or the engaging recess portion is provided with a first inclined portion inclined while intersecting with an end section of an engaging surface of either the engaging recess portion or the engaging projecting portion over a region from the vicinity of a first end up to the vicinity of a second end in a direction substantially orthogonal to the engaging direction of the engaging projecting portion and the engaging recess portion as viewed from the engaging direction, and the electronic apparatus comprising a fixing structure for thin housings is preferably so formed as to disengage the engaging projecting portion and the engaging recess portion from each other by moving an intersection between the first inclined portion and the end section along the first inclined portion while deflecting at least either the engaging projecting portion or the engaging recess portion when disengaging the engaging projecting portion and the engaging recess portion from each other.

As hereinabove described, the electronic apparatus comprising a fixing structure for thin housings according to the second aspect is so formed as to disengage the engaging projecting portion and the engaging recess portion from each other by moving the intersection between the first inclined portion and the end section along the first inclined portion while deflecting at least either the engaging projecting portion or the engaging recess portion when disengaging the engaging projecting portion and the engaging recess portion from each other. Thus, the electronic apparatus disengages the engaging projecting portion and the engaging recess portion from each other while moving the intersection between the first inclined portion and the end section along the first inclined portion when disengaging the engaging projecting portion and the engaging recess portion from each other (disassembling the engaging projecting portion and the engaging recess portion), whereby the engaging recess portion can be prevented from catching the engaging projecting portion. Consequently, force applied in a disassembling direction can be inhibited from concentrating on engaging surfaces of the engaging projecting portion and the engaging recess portion, whereby the electronic apparatus can be formed to be capable of preventing the engaging projecting portion from breakage when disassembling the engaging projecting portion and the engaging recess portion of the thin housings.

In the aforementioned electronic apparatus comprising a fixing structure for thin housings according to the second aspect, the engaging projecting portion and the engaging recess portion are preferably arranged to come into contact with each other on a side closer to the first end of the first inclined portion than the intersection between the first inclined portion and the end section while the engaging projecting portion and the engaging recess portion are arranged not to come into contact with each other on a side closer to the second end of the first inclined portion than the intersection between the first inclined portion and the end section in a state where the engaging projecting portion and the engaging recess portion engage with each other. According to this structure, retention (engaging state) of the engaging projecting portion and the engaging recess portion can be maintained in the region where the engaging projecting portion and the engaging recess portion are in contact with each other in the state where the engaging projecting portion and the engaging recess portion engage with each other. Further, the engaging projecting portion and the engaging recess portion can be disengaged from each other without applying strong force to the engaging projecting portion and the engaging recess portion from the region, serving as a starting point, where the engaging projecting portion and the engaging recess portion are not in contact with each other.

In the aforementioned electronic apparatus comprising a fixing structure for thin housings according to the second aspect, either the engaging projecting portion or the engaging recess portion is preferably provided with a second inclined portion inclined with respect to the engaging direction for facilitating engagement of the engaging projecting portion and the engaging recess portion, and the electronic apparatus comprising a fixing structure for thin housings is preferably so formed that the angle of inclination of the first inclined portion of the engaging surface of either the engaging projecting portion or the engaging recess portion is smaller than the angle of inclination of the second inclined portion. According to this structure, the intersection between the first inclined portion and the end section can be rendered easily movable along the first inclined portion when disengaging the engaging projecting portion and the engaging recess portion from each other due to the relatively small (loose) angle of inclination of the first inclined portion as compared with a case where the fixing structure for thin housings is so formed that the angle of inclination of the first inclined portion is larger than the angle of inclination of the second inclined portion, whereby the engaging projecting portion and the engaging recess portion can be easily disengaged from each other.

In this case, the electronic apparatus comprising a fixing structure for thin housings is preferably so formed that the width of the engaging surface of either the engaging projecting portion or the engaging recess portion in the extensional direction of the first inclined portion is larger than the width in the extensional direction of the second inclined portion. According to this structure, the angle of inclination of the first inclined portion can be easily rendered relatively small due to the relatively large width of the engaging surface in the extensional direction of the first inclined portion as compared with a case where the fixing structure for thin housings is so formed that the width of the engaging surface of either the engaging projecting portion or the engaging recess portion in the extensional direction of the first inclined portion is smaller than the width in the extensional direction of the second inclined portion.

In the aforementioned electronic apparatus comprising a fixing structure for thin housings according to the second aspect, a clearance is preferably formed between the second end of the first inclined portion and the end section of the engaging surface of either the engaging recess portion or the engaging projecting portion as viewed from the engaging direction in a state where the engaging projecting portion and the engaging recess portion engage with each other. According to this structure, the first inclined portion can be rendered easily deflectable when force is applied in a direction for disengaging the engaging projecting portion and the engaging recess portion from each other dissimilarly to a case where no clearance is formed between the second end of the first inclined portion and the end section of the engaging surface of either the engaging recess portion or the engaging projecting portion, whereby the engaging projecting portion and the engaging recess portion can be more easily disengaged from each other.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a portable BD (Blu-ray Disc) player according to an embodiment of the present invention;

FIG. 2 is a front elevational view of the portable BD player according to the embodiment of the present invention;

FIG. 3 is a sectional view of the portable BD player taken along the line 100-100 in FIG. 2;

FIG. 4 is a sectional view for illustrating an engaging state between a front housing and a rear housing of the portable BD player according to the embodiment of the present invention;

FIG. 5 is a back elevational view of the front housing of the portable BD player according to the embodiment of the present invention;

FIG. 6 is a perspective view showing an engaging projecting portion formed on the front housing of the portable BD player according to the embodiment of the present invention;

FIG. 7 is a back elevational view of the rear housing of the portable BD player according to the embodiment of the present invention;

FIG. 8 is a perspective view showing an engaging recess portion formed on the rear housing of the portable BD player according to the embodiment of the present invention;

FIG. 9 is a perspective view showing engaging projecting portions formed on the rear housing of the portable BD player according to the embodiment of the present invention;

FIG. 10 is a plan view for illustrating the engaging state between the front housing and the rear housing of the portable BD player according to the embodiment of the present invention;

FIG. 11 is a sectional view of the portable BD player taken along the line 300-300 in FIG. 10;

FIG. 12 is a sectional view of the portable BD player taken along the line 400-400 in FIG. 10;

FIG. 13 is a diagram for illustrating a detaching direction in disassembling of the front housing and the rear housing of the portable BD player according to the embodiment of the present invention;

FIG. 14 is a diagram for illustrating a state before mounting of the front housing and the rear housing of the portable BD player according to the embodiment of the present invention;

FIG. 15 is a diagram for illustrating a state during mounting of the front housing and the rear housing of the portable BD player according to the embodiment of the present invention;

FIG. 16 is a diagram for illustrating after mounting of the front housing and the rear housing of the portable BD player according to the embodiment of the present invention;

FIG. 17 shows a plan view for illustrating a state before disassembling of the front housing and the rear housing of the portable BD player according to the embodiment of the present invention and a sectional view taken along the line 500-500 in the plan view;

FIG. 18 shows a plan view for illustrating a state during disassembling of the front housing and the rear housing of the portable BD player according to the embodiment of the present invention and a sectional view taken along the line 600-600 in the plan view;

FIG. 19 shows a plan view for illustrating another state during disassembling of the front housing and the rear housing of the portable BD player according to the embodiment of the present invention and a sectional view taken along the line 700-700 in the plan view;

FIG. 20 shows a plan view for illustrating a state after disassembling of the front housing and the rear housing of the portable BD player according to the embodiment of the present invention and a sectional view taken along the line 800-800 in the plan view;

FIG. 21 is a diagram showing a first modification of the shape of the engaging projecting portion formed on the front or rear housing of the portable BD player according to the embodiment of the present invention;

FIG. 22 is a diagram showing a second modification of the shape of the engaging projecting portion formed on the front or rear housing of the portable BD player according to the embodiment of the present invention;

FIG. 23 is a diagram showing a third modification of the shape of the engaging projecting portion formed on the front or rear housing of the portable BD player according to the embodiment of the present invention;

FIG. 24 is a diagram showing a fourth modification of the shape of the engaging recess portion formed on the front or rear housing of the portable BD player according to the embodiment of the present invention;

FIG. 25 is a diagram showing a fifth modification of the shape of the engaging recess portion formed on the front or rear housing of the portable BD player according to the embodiment of the present invention;

FIG. 26 is a diagram showing a sixth modification of the shape of the engaging projecting portion formed on the rear housing of the portable BD player according to the embodiment of the present invention; and

FIG. 27 is a diagram showing a seventh modification for illustrating a detaching direction in disassembling of the front housing and the rear housing of the portable BD player according to the embodiment of the present invention.

### DESCRIPTION OF THE PREFERRED EMBODIMENTS

An embodiment of the present invention is now described with reference to the drawings.

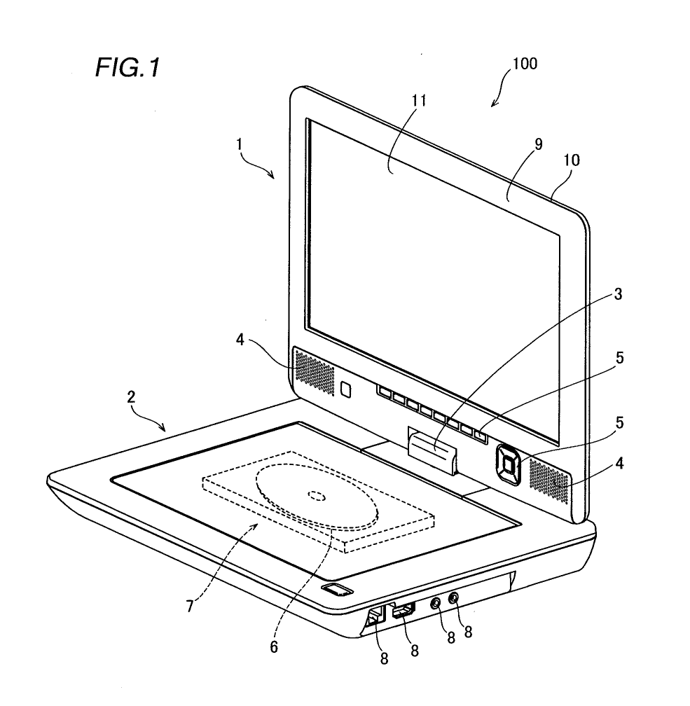

The structure of a portable BD (Blu-ray Disc) player 100 according to the embodiment of the present invention is described with reference to FIGS. 1 to 13.

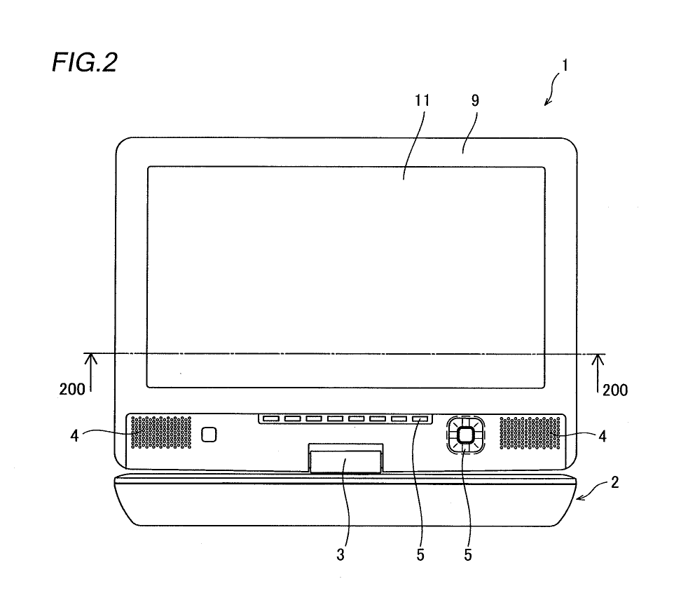

The portable BD player 100 according to the embodiment of the present invention includes a display portion-side body 1 and a disk driving portion-side body 2, as shown in FIGS. 1 and 2. The display portion-side body 1 and the disk driving portion-side body 2 are supported by a hinge portion 3. The display portion-side body 1 is formed to be openable/closable (rotatable) with respect to the disk driving portion-side body 2 on the hinge portion 3 serving as the center of rotation.

The display portion-side body 1 is provided with sound holes 4 for outputting sounds from a speaker (not shown) and operation buttons 5 for allowing various operations. The disk driving portion-side body 2 stores a disk driving portion 7 for playing back contents recorded in a BD (Blu-ray Disk) 6. A plurality of connecting terminals 8 for connecting a LAN cable, a USB cable, an earphone and the like are provided on a side surface of the disk driving portion-side body 2.

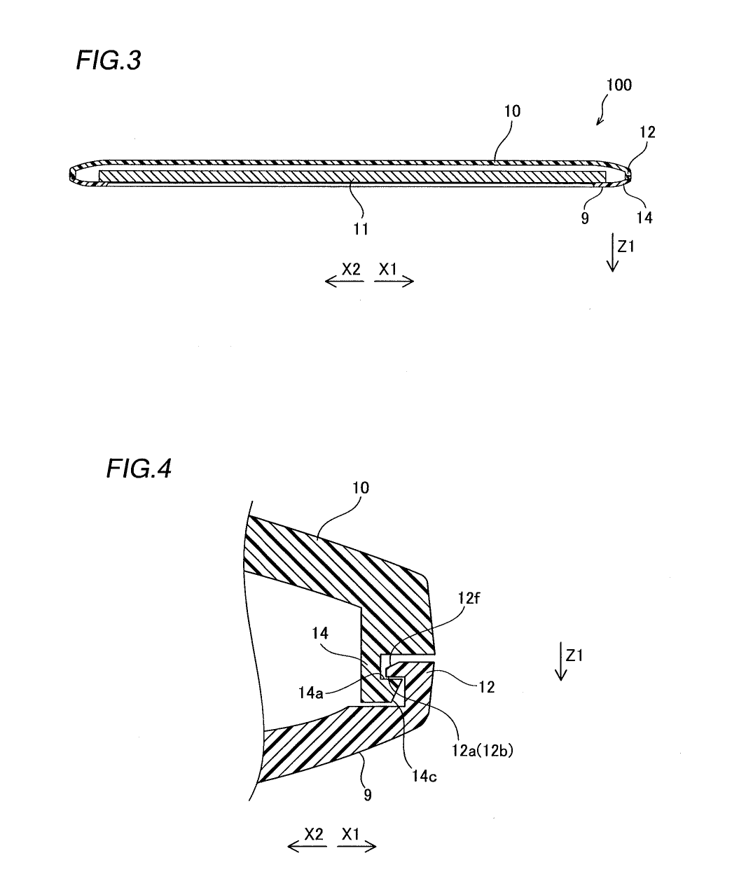

As shown in FIG. 3, the display portion-side body 1 includes a relatively thin and small-sized front housing 9 and a relatively thin and small-sized rear housing 10. The front housing 9 is an example of the “first housing” in the present invention, and the rear housing 10 is an example of the “second housing” in the present invention. The front housing 9 and the rear housing 10 are made of resin. A display panel 11 such as a liquid crystal display is provided between the front housing 9 and the rear housing 10. As shown in FIGS. 3 and 4, the portable BD player 100 is so formed that outer peripheral sides (outer edge portions) of the front housing 9 and outer peripheral sides (outer edge portions) of the rear housing 10 engage with each other thereby fixing the front hosing 9 and the rear housing 10 to each other.

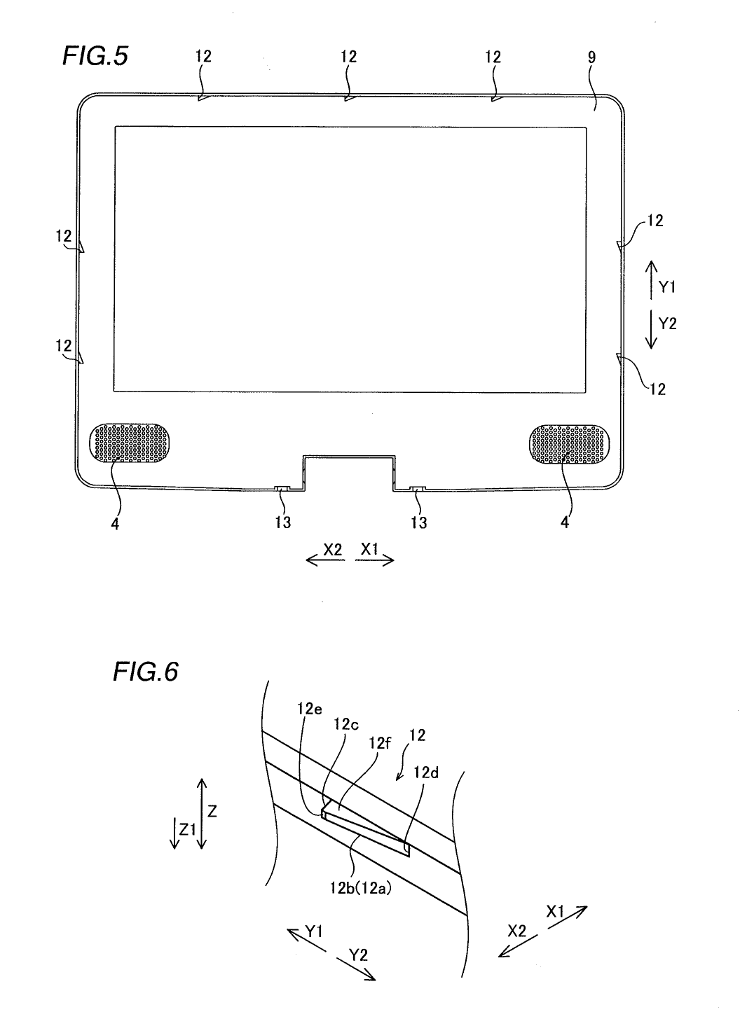

As shown in FIG. 5, the front housing 9 has a substantially rectangular shape in plan view (as viewed from above). Seven front engaging projecting portions 12 are formed on the back surface of the front housing 9 along three outer peripheral sides thereof. Each front engaging projecting portion 12 is formed to protrude inward from an outer side of the substantially rectangular front housing 9, as shown in FIG. 6. Two, two and three front engaging projecting portions 12 are formed on the outer peripheral sides of the front housing 9 along arrows X1, X2 and Y1 respectively, as shown in FIG. 5. In other words, the front housing 9 is provided with seven front engaging projecting portions 12 in total on the three outer peripheral sides thereof. Further, the front housing 9 is provided with two front engaging recess portions 13 on the remaining outer peripheral side along arrow Y2.

The front engaging projecting portions 12 formed on the outer peripheral side of the front housing 9 along arrow X1 are tapered along arrow Y2 as viewed from an engaging direction. The front engaging projecting portions 12 formed on the outer peripheral side of the front housing 9 along arrow Y1 are tapered along arrow X1 as viewed from the engaging direction. The front engaging projecting portions 12 formed on the outer peripheral side of the front housing 9 along arrow X2 are tapered along arrow Y1 as viewed from the engaging direction.

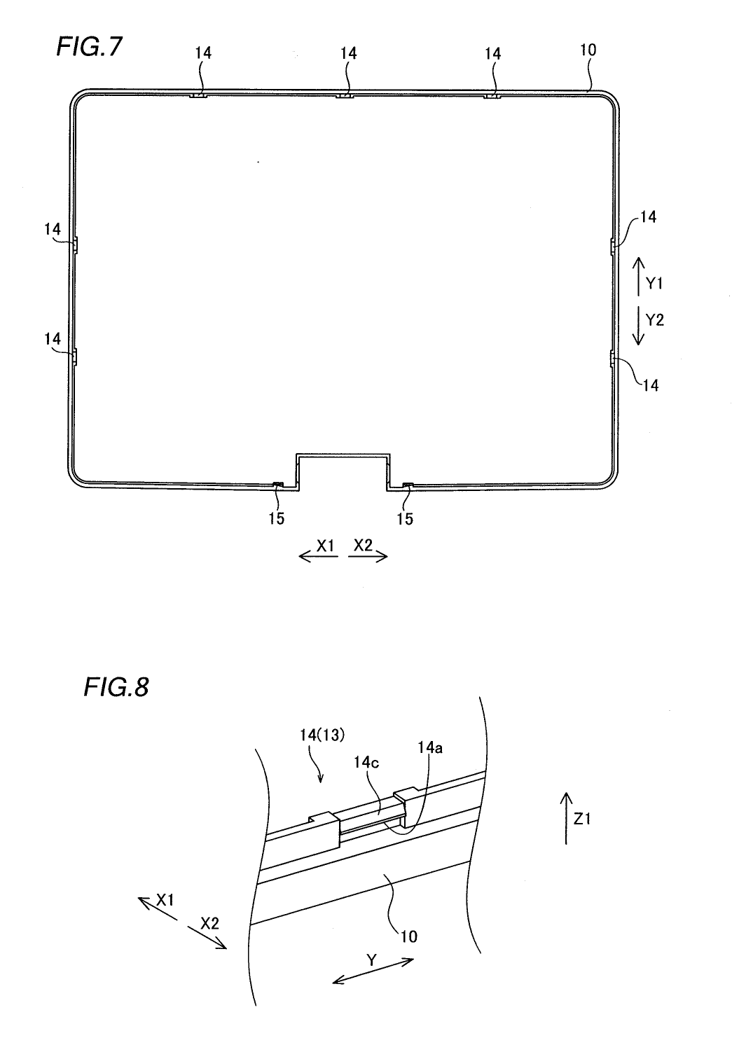

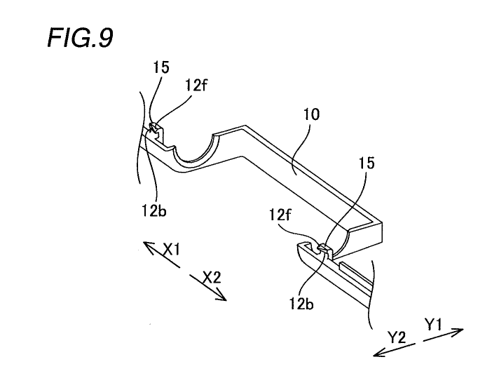

As shown in FIGS. 7 and 8, seven rear engaging recess portions 14 are formed on the back surface of the rear housing 10 along three outer peripheral sides thereof. More specifically, two, two and three rear engaging recess portions 14 are formed on the outer peripheral sides of the rear housing 10 along arrows X1, X2 and Y1 respectively. In other words, the rear housing 10 is provided with seven rear engaging recess portions 14 in total on the three outer peripheral sides thereof. Further, the rear housing 10 is provided with two rear engaging projecting portions 15 on the remaining outer peripheral side along arrow Y2. The two rear engaging projecting portions 15 are formed to protrude outward from an inner side of the rear housing 10 as viewed from the engaging direction of the front housing 9 and the rear housing 10, as shown in FIG. 9. As shown in FIG. 7, the two engaging projecting portions 15 formed on the outer peripheral side of the rear housing 10 along arrow Y2 are tapered oppositely to the hinge portion 3 (see FIG. 2) as viewed from the engaging direction respectively.

The portable BD player 100 is so formed that the seven front engaging projecting portions 12 of the front housing 9 engage with the seven rear engaging recess portions 14 of the rear housing 10 respectively when the front housing 9 and the rear housing 10 engage (are assembled) with each other, as shown in FIG. 4. Further, the portable BD player 100 is so formed that the two rear engaging projecting portions 15 (see FIG. 7) of the rear housing 10 engage with the two front engaging recess portions 13 (see FIG. 5) of the front housing 9 respectively.

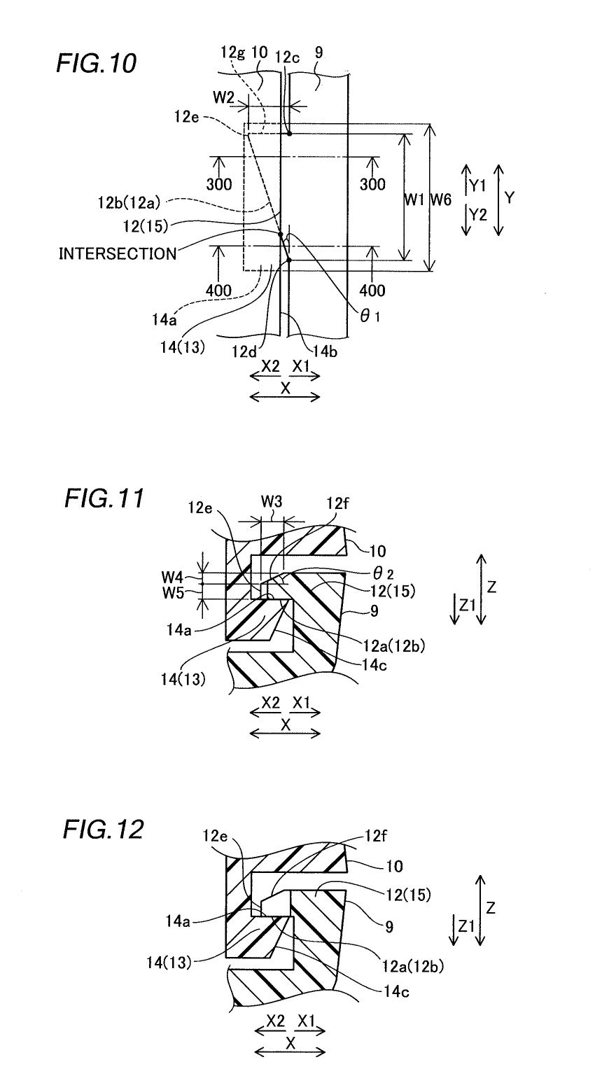

According to this embodiment, an engaging surface 12a of each front engaging projecting portion 12 is in the form of a triangle (right triangle) tapered along arrow Y2 as viewed from the engaging direction (direction Z (see FIG. 6)) of the front engaging projecting portion 12 and the corresponding rear engaging recess portion 14, as shown in FIG. 10.

According to this embodiment, a substantially linear detaching inclined portion 12b is formed over a region from the vicinity of a first end 12c to the vicinity of a second end 12d of each front engaging projecting portion 12 in a direction (direction Y) substantially orthogonal to the engaging direction. The detaching inclined portion 12b is an example of the “first inclined portion” in the present invention. The portable BD player 100 is so formed that a width W1 (see FIG. 10) of each front engaging projecting portion 12 in the extensional direction (direction Y) of the detaching inclined portion 12b is larger than a width (W4+W5) (see FIG. 11) of the front engaging projecting portion 12 in the direction (direction Z) along the engaging direction. Thus, the detaching inclined portion 12b is provided in the form of a thin plate having a relatively small thickness. A top portion 12e of the front engaging projecting portion 12 is in the form of a substantially planar surface. The detaching inclined portion 12b of the front engaging projecting portion 12 is arranged to intersect with an end section 14b of an engaging surface 14a of the corresponding rear engaging recess portion 14 at a prescribed angle θ₁ of inclination. A side section 12g extending in a direction X is arranged on a side closer to a first end (along arrow Y1) of the top portion 12e of the front engaging projecting portion 12, to be substantially orthogonal to the end section 14b of the rear engaging recess portion 14.

The width W1 of the front engaging projecting portion 12 in the extensional direction (direction Y) of the detaching inclined portion 12b is about 4 mm. The maximum width W2 in the direction (direction X) substantially orthogonal to the extensional direction of the detaching inclined portion 12b is about 0.5 mm.

As shown in FIGS. 11 and 12, a mounting inclined portion 12f inclined with respect to the engaging direction (direction Z) is formed on the engaging surface 12a of each front engaging projecting portion 12, in order to facilitate the engagement of the front engaging projecting portion 12 and the corresponding rear engaging recess portion 14. The mounting inclined portion 12f is an example of the “second inclined portion” in the present invention. A width W3 of the mounting inclined portion 12f in the direction X as viewed from the direction Z is about 0.45 mm. A width W4 of the mounting inclined portion 12f in the direction Z is about 0.25 mm. A width W5 from the lower end of the mounting inclined portion 12f to the engaging surface 12a of the detaching inclined portion 12b is about 0.3 mm. On the other hand, a mounting inclined portion 14c inclined with respect to the engaging direction (direction Z) is formed on the rear engaging recess portion 14, in order to facilitate the engagement with the front engaging projecting portion 12. The mounting inclined portion 14c is an example of the “third inclined portion” in the present invention.

As shown in FIG. 10, the angle θ₁ of inclination of the detaching inclined portion 12b with respect to the end section 14b is at least about 4° and not more than about 8°. As shown in FIG. 11, an angle θ₂ of inclination of the mounting inclined portion 12f with respect to an engaging surface 13a (engaging surface 12a) is at least about 23° and not more than about 27°. In other words, the portable BD player 100 is so formed that the angle θ₁ of inclination of the detaching inclined portion 12b with respect to the end section 14b is smaller than the angle θ₂ of inclination of the mounting inclined portion 12f.

As shown in FIG. 10, the front engaging projecting portion 12 is arranged to come into contact with the rear engaging recess portion 14 on the engaging surface 12a (engaging surface 14a) on a side (along arrow Y1) closer to the first end 12c of the detaching inclined portion 12b than an intersection between the detaching inclined portion 12b and the end section 14b in the state where the front engaging projecting portion 12 and the rear engaging recess portion 14 engage with each other.

As shown in FIG. 12, the front engaging projecting portion 12 is arranged not to come into contact with the rear engaging recess portion 14 on a side (along arrow Y2) closer to the second end 12d of the detaching inclined portion 12b than the intersection between the detaching inclined portion 12b and the end section 14b in the state where the front engaging projecting portion 12 and the rear engaging recess portion 14 engage with each other. As shown in FIG. 10, a clearance is formed between the second end 12d of the detaching inclined portion 12b and the end section 14b at a prescribed interval.

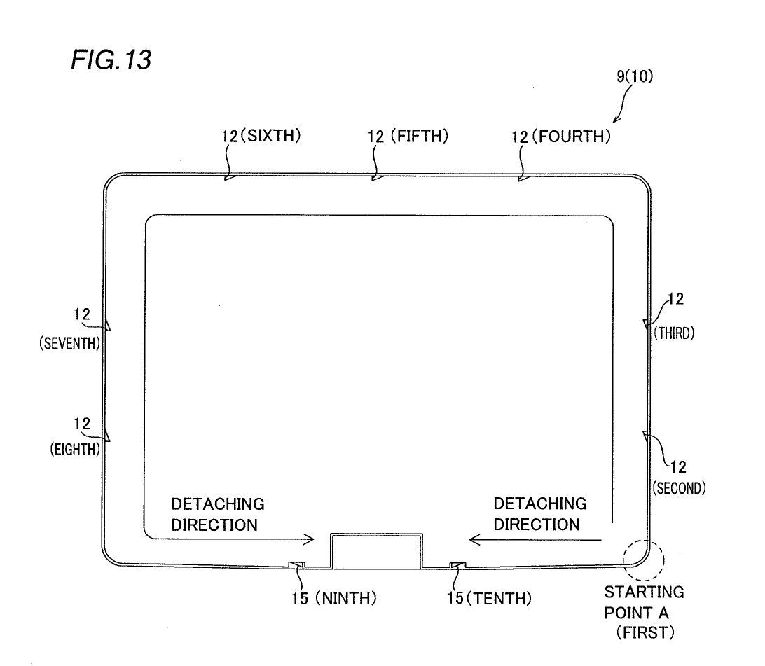

As shown in FIG. 13, the portable BD player 100 is so formed that the directions of inclination of the front engaging projecting portions 12 and the (ninth) rear engaging projecting portion 15 are unified along a direction for successively detaching the front housing 9 and the rear housing 10 from each other from a position (starting point A) serving as a starting point for disengaging the front engaging projecting portions 12 and the rear engaging recess portions 14 from each other respectively when the front housing 9 is observed from the side of the rear housing 10 in the state where the front engaging projecting portions 12 and the rear engaging recess portions 14 engage with each other. Further, the portable BD player 100 is so formed that the direction of inclination of the (tenth) rear engaging projecting portion 15 is inclined along a direction for detaching the front housing 9 and the rear housing 10 from each other from the starting point A toward the (tenth) rear engaging projecting portion 15.

More specifically, assuming that the starting point A is set on an initial (first) position for disengaging the front engaging projecting portions 12 and the rear engaging recess portions 14 from each other, the directions of inclination of the secondly to ninthly disengaged front engaging projecting portions 12 are so unified that the directions of inclination are identical to each other anticlockwise with reference to the starting point A. The tenthly disengaged rear engaging projecting portion 15 is formed to be inclined clockwise from the starting point A with reference to the position (starting point A) serving as the starting point for disengaging the front engaging projecting portions 12 and the rear engaging recess portions 14 from each other.

The rear engaging projecting portions 15 of the rear housing 10 are similar in structure to the front engaging projecting portions 12 of the front housing 9. The front engaging recess portions 13 of the front housing 9 are similar in structure to the rear engaging recess portions 14 of the rear housing 10.

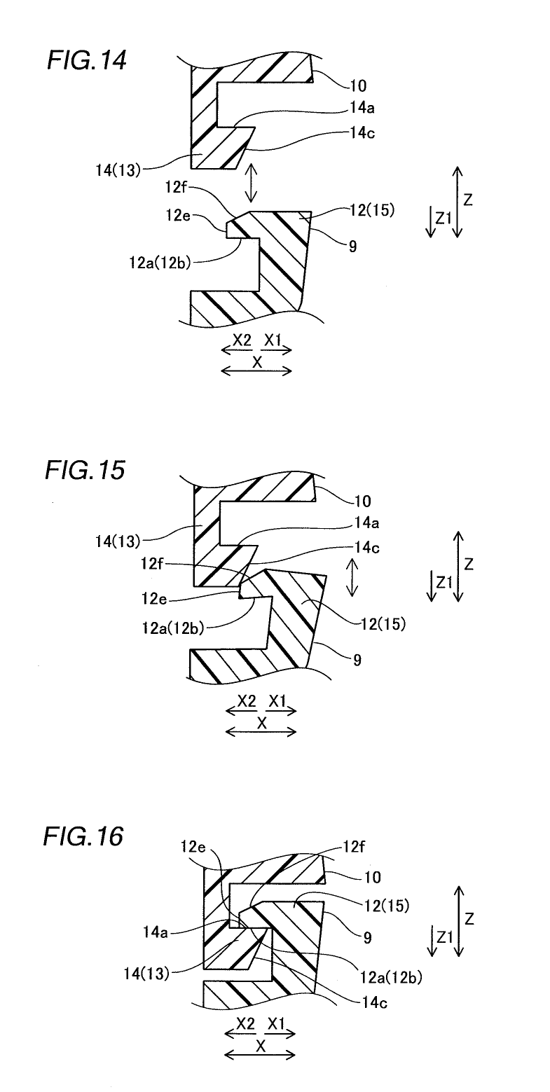

An operation of assembling the front housing 9 and the rear housing 10 with each other is now described with reference to FIGS. 14 to 16.

In order to assemble the front housing 9 and the rear housing 10 with each other, force in the engaging direction (direction Z) is first applied to the front housing 9 and the rear housing 10 as shown in FIG. 14, whereby the mounting inclined portion 12f of each front engaging projecting portion 12 comes into contact with the mounting inclined portion 14c of the corresponding rear engaging recess portion 14, as shown in FIG. 15.

Thereafter the force in the engaging direction (direction Z) is further applied to the front housing 9 and the rear housing 10, whereby each front engaging projecting portion 12 begins to be deflected along arrow X1 in the state where the mounting inclined portion 12f thereof is in contact with the mounting inclined portion 14c of the corresponding rear engaging recess portion 14. The force in the engaging direction (direction Z) is further applied to the front housing 9 and the rear housing 10 so that each front engaging projecting portion 12 is fitted into the corresponding rear engaging recess portion 14 as shown in FIG. 16, whereby the front housing 9 and the rear housing 10 engage (are assembled) with each other.

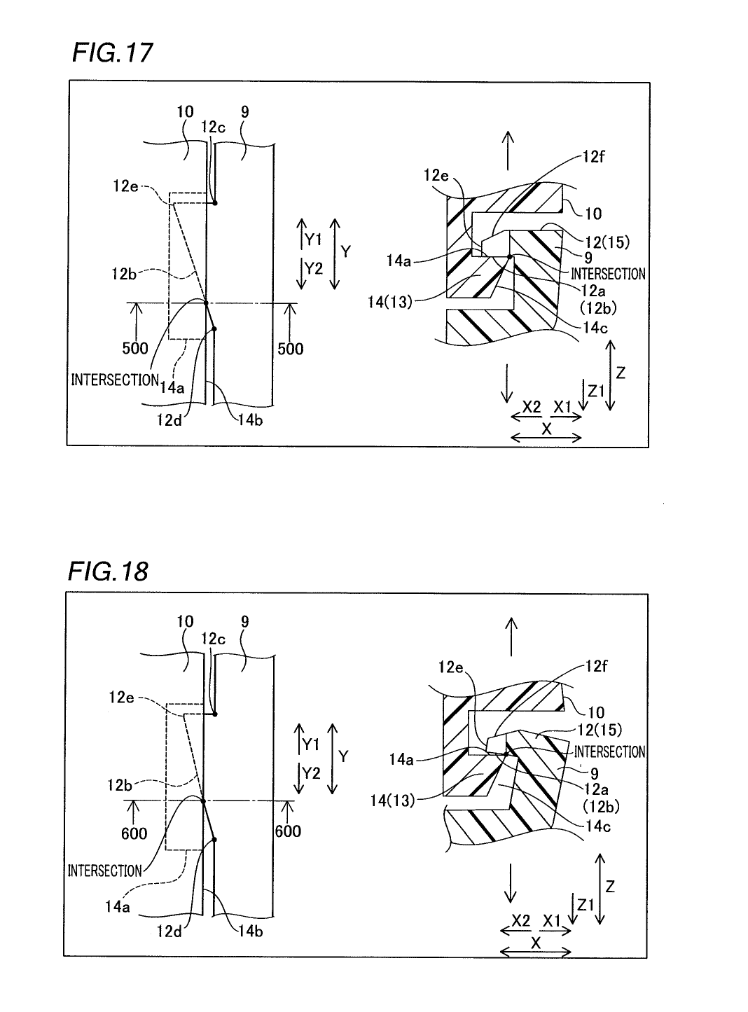

An operation of disassembling the front housing 9 and the rear housing 10 (detaching the front housing 9 and the rear housing 10 from each other) is now described with reference to FIGS. 17 to 20.

First, force is applied to the front housing 9 and the rear housing 10 in a direction for separating the same from each other from the state where each front engaging projecting portion 12 and the corresponding rear engaging recess portion 14 engage with each other, as shown in FIG. 17.

As shown in FIG. 18, the detaching inclined portion 12b of the front engaging projecting portion 12 begins to be deflected along arrow X1, while the intersection A between the detaching inclined portion 12b and the end section 14b of the engaging surface 14a of the rear engaging recess portion 14 is gradually moved in the direction (along arrow Y1) of the first end 12c of the detaching inclined portion 12b along the detaching inclined portion 12b. At this time, the detaching inclined portion 12b of the front engaging projecting portion 12 begins to gradually come off the end section 14b of the engaging surface 14a along arrow X1.

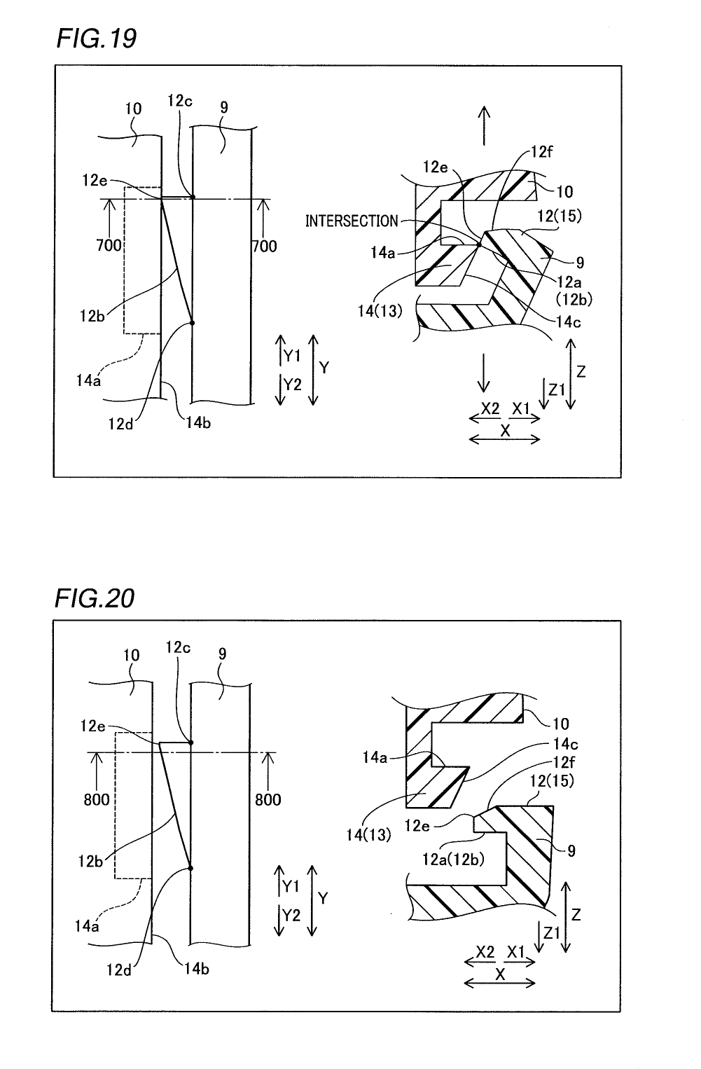

The force is further applied to the front housing 9 and the rear housing 10 in the direction for separating the same from each other so that the intersection A between the detaching inclined portion 12b and the end section 14b is moved up to the top portion 12e as shown in FIG. 19 and the detaching inclined portion 12b of the front engaging projecting portion 12 and the end section 14b of the engaging surface 14a of the rear engaging recess portion 14 thereafter completely separate from each other as shown in FIG. 20, whereby the front engaging projecting portion 12 and the rear engaging recess portion 14 are disengaged from each other. In other words, the front housing 9 and the rear housing 10 are disassembled.

According to this embodiment, as hereinabove described, the portable BD player 100 is so formed as to disengage each front engaging projecting portion 12 and the corresponding rear engaging recess portion 14 from each other by moving the intersection A between the linear detaching inclined portion 12b and the end section 14b along the linear detaching inclined portion 12b while deflecting the front engaging projecting portion 12 when disengaging the front engaging projecting portion 12 and the rear engaging recess portion 14 from each other. Thus, the portable BD player 100 disengages the front engaging projecting portion 12 and the rear engaging recess portion 14 from each other while moving the intersection A between the detaching inclined portion 12b and the end section 14b along the detaching inclined portion 12b when disengaging the front engaging projecting portion 12 and the rear engaging recess portion 14 from each other (disassembling the front engaging projecting portion 12 and the rear engaging recess portion 14), whereby the rear engaging recess portion 14 can be prevented from catching the front engaging projecting portion 12. Consequently, force applied in a disassembling direction (engaging direction) can be inhibited from concentrating on the engaging surfaces 12a and 14a of the front engaging projecting portion 12 and the rear engaging recess portion 14, whereby the front engaging projecting portion 12 can be prevented from breakage when the thin front housing 9 and the thin rear housing 10 are disassembled.

According to this embodiment, as hereinabove described, each front engaging projecting portion 12 and the corresponding rear engaging recess portion 14 are arranged to come into contact with each other on the side closer to the first end 12c of the detaching inclined portion 12b than the intersection A between the detaching inclined portion 12b and the end section 14b and arranged not to come into contact with each other on the side closer to the second end 12d of the detaching inclined portion 12b than the intersection A between the detaching inclined portion 12b and the end section 14b in the state where the front engaging projecting portion 12 and the rear engaging recess portion 14 engage with each other. Thus, retention (engaging state) of the front engaging projecting portion 12 and the rear engaging recess portion 14 can be maintained in the region where the front engaging projecting portion 12 and the rear engaging recess portion 14 are in contact with each other in the state where the front engaging projecting portion 12 and the rear engaging recess portion 14 engage with each other. Further, the front engaging projecting portion 12 and the rear engaging recess portion 14 can be disengaged from each other without applying strong force to the front engaging projecting portion 12 and the rear engaging recess portion 14 from the region, serving as the starting point, where the front engaging projecting portion 12 and the rear engaging recess portion 14 are not in contact with each other when disengaging the front engaging projecting portion 12 and the rear engaging recess portion 14 from each other.

According to this embodiment, as hereinabove described, the portable BD player 100 is so formed as to disengage each front engaging projecting portion 12 and the corresponding rear engaging recess portion 14 from each other by moving the intersection A between the detaching inclined portion 12b and the end section 14b from the second end 12d along the first end 12c of the detaching inclined portion 12b while deflecting at least either the front engaging projecting portion 12 or the rear engaging recess portion 14 when disengaging the front engaging projecting portion 12 and the rear engaging recess portion 14 from each other. Thus, the front engaging projecting portion 12 and the rear engaging recess portion 14 can be easily disengaged from each other by moving the intersection A between the detaching inclined portion 12b and the end section 14b from the second end 12d along the first end 12c of the detaching inclined portion 12b when disengaging the front engaging projecting portion 12 and the rear engaging recess portion 14 from each other (disassembling the front engaging projecting portion 12 and the rear engaging recess portion 14).

According to this embodiment, as hereinabove described, the portable BD player 100 is so formed that the angle θ₁ of inclination of the detaching inclined portion 12b of the engaging surface 12a of the front engaging projecting portion 12 is smaller than the angle θ₂ of inclination of the mounting inclined portion 12f. Thus, the intersection A between the detaching inclined portion 12b and the end section 14b can be rendered easily movable along the detaching inclined portion 12b when disengaging the front engaging projecting portion 12 and the rear engaging recess portion 14 from each other due to the relatively small (loose) angle θ₁ of inclination of the detaching inclined portion 12b as compared with a case where the portable BD player 100 is so formed that the angle θ₁ of inclination of the detaching inclined portion 12b is larger than the angle θ₂ of inclination of the mounting inclined portion 12f, whereby the front engaging projecting portion 12 and the rear engaging recess portion 14 can be easily disengaged from each other.

According to this embodiment, as hereinabove described, each rear engaging recess portion 14 is provided with the mounting inclined portion 14c coming into contact with the mounting inclined portion 12f provided on the corresponding front engaging projecting portion 12 when the front engaging projecting portion 12 and the rear engaging recess portion 14 engage with each other. Thus, the front engaging projecting portion 12 and the rear engaging recess portion 14 can be smoothly moved along the mounting inclined portions 12f and 14c when engaging with each other, whereby the front engaging projecting portion 12 and the rear engaging recess portion 14 can easily engage with each other.

According to this embodiment, as hereinabove described, the portable BD player 100 is so formed that the width W1 of the engaging surface 12a of each front engaging projecting portion 12 along the extensional direction of the detaching inclined portion 12b is larger than the width W4 in the extensional direction of the mounting inclined portion 12f. Thus, the angle θ₁ of inclination of the detaching inclined portion 12b can be easily rendered relatively small due to the relatively large width W1 of the engaging surface 12a in the extensional direction Y of the detaching inclined portion 12b, as compared with a case where the portable BD player 100 is so formed that the width W1 of the engaging surface 12a of the front engaging projecting portion 12 along the extensional direction Y of the detaching inclined portion 12b is smaller than the width W4 in the extensional direction of the mounting inclined portion 12f.

According to this embodiment, as hereinabove described, the portable BD player 100 is so formed that the width W1 of each front engaging projecting portion 12 in the extensional direction (direction Y) of the detaching inclined portion 12b is smaller than a width W6 of each rear engaging recess portion 14 in the direction (direction Y) along the extensional direction of the detaching inclined portion 12b. Thus, the front engaging projecting portion 12 and the rear engaging recess portion 14 can easily engage with each other due to the small width W1 of the front engaging projecting portion 12 in the extensional direction (direction Y) of the detaching inclined portion 12b, when the front engaging projecting portion 12 and the rear engaging recess portion 14 engage with each other.

According to this embodiment, as hereinabove described, the portable BD player 100 is so formed that the width W1 of each front engaging projecting portion 12 in the extensional direction (direction Y) of the detaching inclined portion 12b is larger than the width (W4+W5) of the front engaging projecting portion 12 in the direction (direction Z) along the engaging direction. Thus, the sizes of engaging portions (regions) are increased due to the large width W1 of the front engaging projecting portion 12 in the extensional direction (direction Y) of the detaching inclined portion 12b, whereby the front engaging projecting portion 12 and the rear engaging recess portion 14 can reliably engage with each other.

According to this embodiment, as hereinabove described, the clearance is formed between the second end 12d of the detaching inclined portion 12b of each front engaging projecting portion 12 and the end section 14b of the engaging surface 14a of the corresponding rear engaging recess portion 14 as viewed from the engaging direction (direction Z) in the state where the front engaging projecting portion 12 and the rear engaging recess portion 14 engage with each other. Thus, the detaching inclined portion 12b can be rendered easily deflectable when force is applied in the direction (direction Z) for disengaging the front engaging projecting portion 12 and the rear engaging recess portion 14 from each other dissimilarly to a case where no clearance is formed between the second end 12d of the detaching inclined portion 12b and the end section 14b of the rear engaging recess portion 14, whereby the front engaging projecting portion 12 and the rear engaging recess portion 14 can be more easily disengaged from each other.

According to this embodiment, as hereinabove described, the portable BD player 100 is so formed that the directions of inclination of the detaching inclined potions 12b of the engaging surfaces 12a of nine front engaging projecting portions 12 are unified along the direction for successively detaching the front housing 9 and the rear housing 10 from each other from the position serving as the starting point for disengaging the front engaging projecting portions 12 and the rear engaging recess portions 14 from each other. Thus, the front engaging projecting portions 12 and the rear engaging recess portions 14 can be successively continuously smoothly disengaged from each other from the position (starting point A) serving as the starting point for disengaging the front engaging projecting portions 12 and the rear engaging recess portions 14 from each other when force is applied (the front housing 9 and the rear housing 10 are pulled) in the direction for detaching the front housing 9 and the rear housing 10 from each other.

According to this embodiment, as hereinabove described, the second end 12d of the detaching inclined portion 12b of each front engaging projecting portion 12 is arranged on a side closer to the position serving as the starting point for disengaging the front engaging projecting portion 12 and the corresponding rear engaging recess portion 14 from each other, while the first end 12c of the detaching inclined portion 12b is arranged on a side closer to a forward end in the direction for successively detaching the front housing 9 and the rear housing 10 from each other. Thus, the second end 12d of the detaching inclined portion 12b arranged on the side closer to the position (starting point A) serving as the starting point for disengaging the front engaging projecting portion 12 and the rear engaging recess portion 14 from each other can be easily detached from the end section 14b of the rear engaging recess portion 14 when force is applied (the front housing 9 and the rear housing 10 are pulled) in the direction for detaching the front housing 9 and the rear housing 10 from each other.

According to this embodiment, as hereinabove described, each front engaging projecting portion 12 has the triangular shape protruding toward the corresponding rear engaging recess portion 14 (along arrow X2) as viewed from the engaging direction (direction Z), due to the detaching inclined portion 12b and the side section 12g. Thus, the front engaging projecting portion 12 and the rear engaging recess portion 14 can be disengaged from each other by moving the intersection A between the detaching inclined portion 12b and the end section 14b along the detaching inclined portion 12b by the detaching inclined portion 12b while regulating movement of the front engaging projecting portion 12 and the rear engaging recess portion 14 in the extensional direction (direction Y) of the detaching inclined portion 12b through the side section 12g of the front engaging projecting portion 12.

According to this embodiment, as hereinabove described, each front engaging projecting portion 12 includes the top portion 12e in the form of a substantially planar surface connecting the side closer to the first end 12c of the detaching inclined portion 12b and the side of the side section 12g closer to the rear engaging recess portion 14 with each other as viewed from the engaging direction (direction Z) of the front engaging projecting portion 12 and the rear engaging recess portion 14. Thus, the quantity of protrusion of the front engaging projecting portion 12 can be reduced dissimilarly to a case where the front engaging projecting portion 12e has a sharp top portion 12e, whereby the front engaging projecting portion 12 and the rear engaging recess portion 14 can be easily disengaged from each other.

Although the present invention has been described and illustrated in detail, it is clearly understood that the same is by way of illustration and example only and is not to be taken by way of limitation, the spirit and scope of the present invention being limited only by the terms of the appended claims.

For example, while the fixing structure for thin housings according to the present invention is applied to the front housing and the rear housing of the portable BD player in the aforementioned embodiment, the present invention is not restricted to this. The present invention is also applicable to a PC (Personal Computer), a portable telephone or an electronic book, for example, so far as the same has thin miniature housings.

While the front housing and the rear housing are applied as examples of the first housing and the second housing in the present invention respectively in the aforementioned embodiment, the present invention is not restricted to this. Alternatively, a rear housing and a front housing may be applied as the first housing and the second housing in the present invention respectively, for example.

While the front housing is provided with the seven front engaging projecting portions and the two engaging recess portions and the rear housing is provided with the seven rear engaging recess portions and the two rear engaging projecting portions in the aforementioned embodiment, the present invention is not restricted to this. Alternatively, the front housing may be provided with engaging projecting portions in a number other than seven, and the rear housing may be provided with engaging recess portions in a number other than seven, for example. Further alternatively, the front housing may be provided with engaging recess portions in a number other than two, and the rear housing may be provided with engaging projecting portions in a number other than two.

While the front engaging projecting portion 12 closest to the starting point A is secondly disengaged from the corresponding rear engaging recess portion 14 and the rear engaging projecting portion 15 closest to the starting point A is tenthly disengaged from the corresponding front engaging recess portion 13 assuming that the initial (first) position for disengaging the front engaging projecting portions 12 and the rear engaging recess portions 14 from each other is set to the starting point A in the aforementioned embodiment as shown in FIG. 13, the present invention is not restricted to this. Alternatively, the rear engaging projecting portion 15 closest to the starting point A may be secondly disengaged from the corresponding front engaging recess portion 13 and the front engaging projecting portion 12 closest to the starting point A may be thirdly disengaged from the corresponding rear engaging recess portion 14 assuming that the initial (first) position for disengaging the front engaging projecting portions 12 and the rear engaging recess portions 14 from each other is set to the starting point A, for example. Further alternatively, the rear engaging projecting portion 15 and the front engaging projecting portion 12 closest to the starting point A may be substantially simultaneously secondly disengaged from the corresponding front engaging recess portion 13 and the corresponding rear engaging recess portion 14 respectively.

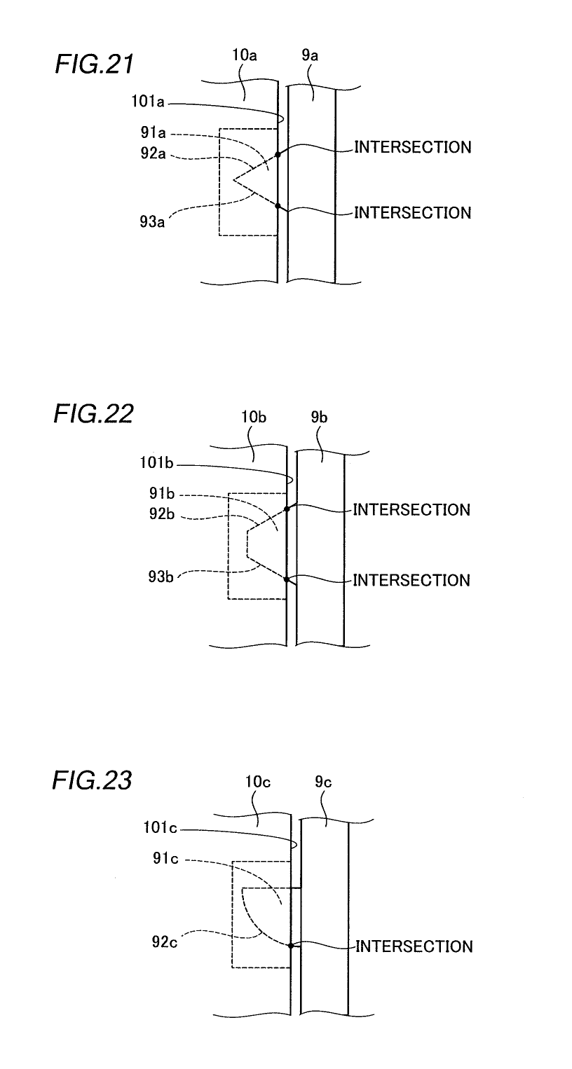

While the front housing is provided with the front engaging projecting portions each of which is substantially in the form of a right triangle as viewed from the engaging direction in the aforementioned embodiment, the present invention is not restricted to this. Alternatively, a front housing 9a may be provided with an engaging projecting portion 91a in the form of an isosceles triangle as in a first modification shown in FIG. 21, for example. In order to disassemble the front housing 9a and a rear housing 10a in this case, two inclined portions 92a and 93a of the engaging projecting portion 91a and an end section 101a of an engaging surface of the rear housing 10a are disengaged from each other by moving two intersections between the two inclined portions 92a and 93a and the end section 101a along the two inclined portions 92a and 93a.

While the front housing is provided with the front engaging projecting portions each of which is substantially in the form of a right triangle as viewed from the engaging direction in the aforementioned embodiment, the present invention is not restricted to this. Alternatively, a front housing 9b may be provided with a trapezoidal engaging projecting portion 91b as in a second modification shown in FIG. 22, for example. In order to disassemble the front housing 9b and a rear housing 10b in this case, two inclined portions 92b and 93b of the engaging projecting portion 91b and an end section 101b of an engaging surface of the rear housing 10b are disengaged from each other by moving two intersections between the two inclined portions 92b and 93b and the end section 101b along the two inclined portions 92b and 93b.

While the front housing is provided with the first inclined portion linear as viewed from the engaging direction in the aforementioned embodiment, the present invention is not restricted to this. Alternatively, a front housing 9c may be provided with an engaging projecting portion 91c having a curved inclined portion 92c as in a third modification shown in FIG. 23, for example. In order to disassemble the front housing 9c and a rear housing 10c in this case, the inclined portion 92c of the engaging projecting portion 91c and an end section 101c of an engaging surface of the rear housing 10c are disengaged from each other by moving an intersection between the inclined portion 92c and the end section 101c along the curved inclined portion 92c.

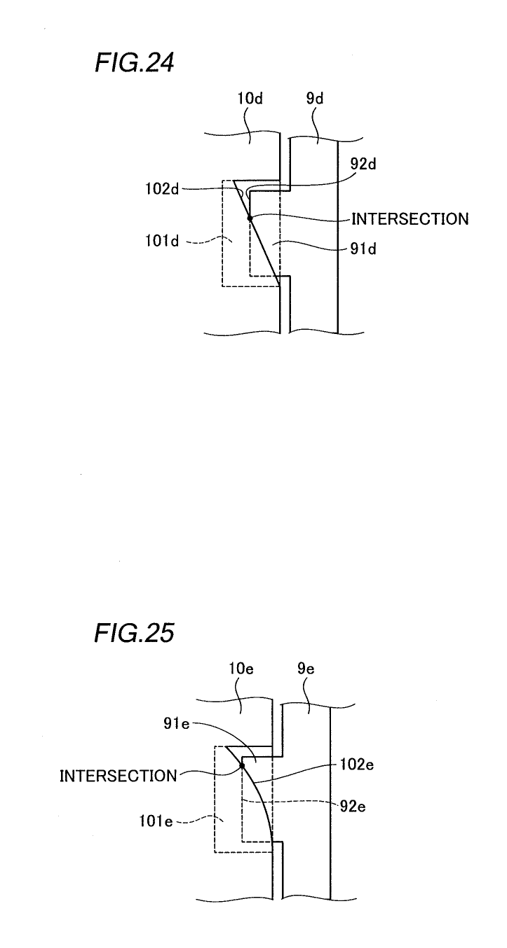

While each front engaging projecting portion (rear engaging projecting portion) is provided with the first inclined portion in the aforementioned embodiment, the present invention is not restricted to this. Alternatively, a front housing 9d may be provided with an engaging projecting portion 91d substantially rectangular as viewed from an engaging direction and an engaging surface of an engaging recess portion 101d formed on a rear housing 10d may be provided with a linear inclined portion 12d as in a fourth modification shown in FIG. 24, for example. In order to disassemble the front housing 9d and the rear housing 10d in this case, the inclined portion 102d of the engaging surface of the rear housing 10d and an end section 92d of the engaging projecting portion 91d are disengaged from each other by moving an intersection between the end section 92d and the inclined portion 102d along the linear inclined portion 102d.

While each front engaging projecting portion (rear engaging projecting portion) is provided with the first inclined portion in the aforementioned embodiment, the present invention is not restricted to this. Alternatively, a front housing 9e may be provided with an engaging projecting portion 91e substantially rectangular as viewed from an engaging direction and an engaging surface of an engaging recess portion 101e formed on a rear housing 10e may be provided with a curved inclined portion 102e as in a fifth modification shown in FIG. 25, for example. In order to disassemble the front housing 9e and the rear housing 10e in this case, the inclined portion 102e of the engaging surface of the rear housing 10e and the end section 92e of the engaging projecting portion 91e are disengaged from each other by moving an intersection between the end section 92e and the inclined portion 102e along the curved inclined portion 102e.

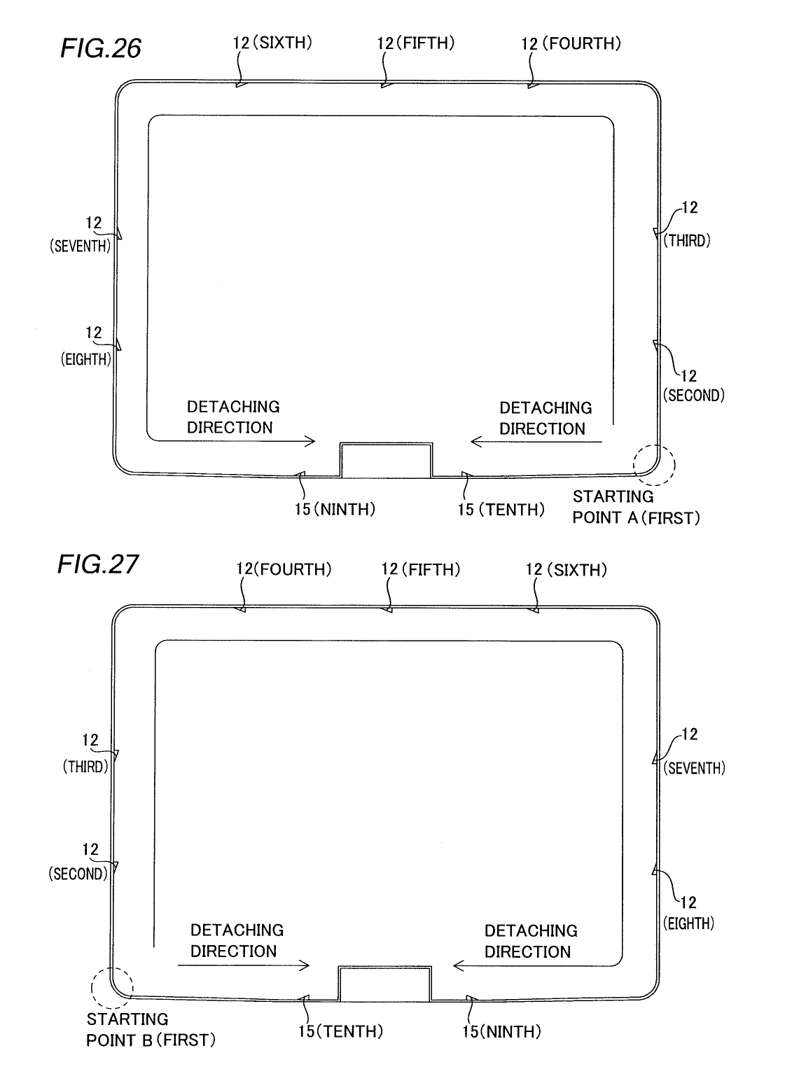

While the front engaging projecting portions are formed to protrude inward (toward the display panel) from the outer side of the front housing and the rear engaging projecting portions are formed to protrude outward from the inner side of the rear housing in the aforementioned embodiment, the present invention is not restricted to this. Alternatively, front engaging projecting portions 12 may be formed to protrude inward from an outer side of a front housing and rear engaging projecting portions 15 may be formed to protrude inward from an outer side of a rear housing as in a sixth modification shown in FIG. 26, for example.

While the portable BD player is so formed that the directions of inclination are identical to each other along the order (second to ninth) of detaching the front housing and the rear housing from each other anticlockwise assuming that the starting point A is set on the initial position for disengaging the front engaging projecting portions (rear engaging projecting portions) and the rear engaging recess portions (front engaging recess portions) from each other in the aforementioned embodiment, the present invention is not restricted to this. Alternatively, a portable BD player may be so formed that the directions of front engaging projecting portions (rear engaging projecting portions) secondly to ninthly disengaged from rear engaging recess portions (front engaging recess portions) are unified clockwise to be identical to each other with reference to a starting point B assuming that the starting point B is set on an initial (first) position for disengaging the front engaging projecting portions (rear engaging projecting portions) and the rear engaging recess portions (front engaging recess portions) from each other as in a seventh modification shown in FIG. 27, for example. Further, a rear engaging projecting portion of a rear housing tenthly disengaged from a corresponding front engaging recess portion is preferably formed to be inclined anticlockwise with reference to the position (starting point B) serving as the starting point for disengaging the front engaging projecting portions (rear engaging projecting portions) and the rear engaging recess portions (front engaging recess portions) from each other.

What is claimed is:

1. A fixing structure for thin housings, comprising:
a thin first housing including at least either an engaging projecting portion or an engaging recess portion; and
a thin second housing including at least either said engaging recess portion or said engaging projecting portion engaging with at least either said engaging projecting portion or said engaging recess portion of said first housing, wherein
an engaging surface of either said engaging projecting portion or said engaging recess portion is provided with a first inclined portion inclined while intersecting with an end section of an engaging surface of either said engaging recess portion or said engaging projecting portion over a region from the vicinity of a first end up to the vicinity of a second end in a direction substantially orthogonal to an engaging direction of said engaging projecting portion and said engaging recess portion as viewed from said engaging direction, and
the fixing structure for thin housings is so formed as to disengage said engaging projecting portion and said engaging recess portion from each other by moving an intersection between said first inclined portion and said end section along said first inclined portion while deflecting at least either said engaging projecting portion or said engaging recess portion when disengaging said engaging projecting portion and said engaging recess portion from each other.

2. The fixing structure for thin housings according to claim 1, wherein
said engaging projecting portion and said engaging recess portion are arranged to come into contact with each other on a side closer to said first end of said first inclined portion than said intersection between said first inclined portion and said end section while said engaging projecting portion and said engaging recess portion are arranged not to come into contact with each other on a side closer to said second end of said first inclined portion than said intersection between said first inclined portion and said end section in a state where said engaging projecting portion and said engaging recess portion engage with each other.

3. The fixing structure for thin housings according to claim 2, so formed as to disengage said engaging projecting portion and said engaging recess portion from each other by moving said intersection between said first inclined portion and said end section from said side closer to said second end of said first inclined portion along said side closer to said first end while deflecting at least either said engaging projecting portion or said engaging recess portion when disengaging said engaging projecting portion and said engaging recess portion from each other.

4. The fixing structure for thin housings according to claim 1, wherein
either said engaging projecting portion or said engaging recess portion is provided with a second inclined portion inclined with respect to said engaging direction for facilitating engagement of said engaging projecting portion and said engaging recess portion, and
the fixing structure for thin housings is so formed that the angle of inclination of said first inclined portion of said engaging surface of either said engaging projecting portion or said engaging recess portion is smaller than the angle of inclination of said second inclined portion.

5. The fixing structure for thin housings according to claim 4, wherein
either said engaging recess portion or said engaging projecting portion is provided with a third inclined portion coming into contact with said second inclined portion formed on either said engaging projecting portion or said engaging recess portion when said engaging projecting portion and said engaging recess portion engage with each other.

6. The fixing structure for thin housings according to claim 4, so formed that the width of said engaging surface of either said engaging projecting portion or said engaging recess portion in the extensional direction of said first inclined portion is larger than the width in the extensional direction of said second inclined portion.

7. The fixing structure for thin housings according to claim 1, so formed that the width of said engaging surface of either said engaging projecting portion or said engaging recess portion in the extensional direction of said first inclined portion is smaller than the width of said engaging surface of either said engaging recess portion or said engaging projecting portion in a direction along the extensional direction of said first inclined portion.

8. The fixing structure for thin housings according to claim 1, so formed that the width of said engaging surface of either said engaging projecting portion or said engaging recess portion in the extensional direction of said first inclined portion is larger than the width of said engaging projecting portion or said engaging recess portion in a direction along said engaging direction.

9. The fixing structure for thin housings according to claim 1, wherein
a clearance is formed between said second end of said first inclined portion and said end section of said engaging surface of either said engaging recess portion or said engaging projecting portion as viewed from said engaging direction in a state where said engaging projecting portion and said engaging recess portion engage with each other.

10. The fixing structure for thin housings according to claim 1, wherein
a plurality of at least either said engaging projecting portions or said engaging recess portions are formed along the outer periphery of said first housing,
a plurality of at least either said engaging recess portions or said engaging projecting portions are formed along the outer periphery of said second housing, and
the fixing structure for thin housings is so formed that directions of inclination of said first inclined portions of said engaging surfaces of either said plurality of engaging projecting portions or said plurality of engaging recess portions are unified along a direction for successively detaching said first housing and said second housing from each other from a position serving as a starting point for disengaging said engaging projecting portions and said engaging recess portions from each other.

11. The fixing structure for thin housings according to claim 10, wherein
said second ends of said first inclined portions of said engaging surfaces of either said engaging projecting portions or said engaging recess portions are arranged on a side closer to said position serving as said starting point for disengaging said engaging projecting portions and said engaging recess portions from each other while said first ends of said first inclined portions are arranged on a side closer to a forward end in said direction for successively detaching said first housing and said second housing from each other.

12. The fixing structure for thin housings according to claim 1, wherein
the shape of said first inclined portion of either said engaging projecting portion or said engaging recess portion includes a linear shape or a curved shape.

13. The fixing structure for thin housings according to claim 1, wherein
said first inclined portion is formed on said engaging surface of said engaging projecting portion, and so formed as to linearly extend at a substantially constant angle of inclination from the vicinity of said first end to the vicinity of said second end in said direction substantially orthogonal to said engaging direction of said engaging projecting portion and said engaging recess portion as viewed from said engaging direction and as to intersect with said end section of said engaging surface of said engaging recess portion, and
the fixing structure for thin housings is so formed as to disengage said engaging projecting portion and said engaging recess portion from each other by moving said intersection between said linear first inclined portion and said end section along said first inclined portion while deflecting at least either said engaging projecting portion or said engaging recess portion when disengaging said engaging projecting portion and said engaging recess portion from each other.

14. The fixing structure for thin housings according to claim 13, wherein
said engaging projecting portion further includes a side section arranged on said side closer to said first end of said first inclined portion and arranged to be substantially orthogonal to said end section of said engaging surface of said engaging recess portion, and
said engaging projecting portion has a triangular shape protruding toward said engaging recess portion as viewed from said engaging direction due to said first inclined portion and said side section.

15. The fixing structure for thin housings according to claim 14, wherein
said engaging projecting portion has a top portion in the form of a substantially planar surface connecting said side closer to said first end of said first inclined portion and a side of said side section closer to said engaging recess portion as viewed from said engaging direction of said engaging projecting portion and said engaging recess portion.

16. An electronic apparatus comprising a fixing structure for thin housings, wherein
said fixing structure for thin housings comprises:
a thin first housing including at least either an engaging projecting portion or an engaging recess portion; and
a thin second housing including at least either said engaging recess portion or said engaging projecting portion engaging with at least either said engaging projecting portion or said engaging recess portion of said first housing,
an engaging surface of either said engaging projecting portion or said engaging recess portion is provided with a first inclined portion inclined while intersecting with an end section of an engaging surface of either said engaging recess portion or said engaging projecting portion over a region from the vicinity of a first end up to the vicinity of a second end in a direction substantially orthogonal to said engaging direction of said engaging projecting portion and said engaging recess portion as viewed from said engaging direction, and
the electronic apparatus comprising a fixing structure for thin housings is so formed as to disengage said engaging projecting portion and said engaging recess portion from each other by moving an intersection between said first inclined portion and said end section along said first inclined portion while deflecting at least either said engaging projecting portion or said engaging recess portion when disengaging said engaging projecting portion and said engaging recess portion from each other.

17. The electronic apparatus comprising a fixing structure for thin housings according to claim 16, wherein
said engaging projecting portion and said engaging recess portion are arranged to come into contact with each other on a side closer to said first end of said first inclined portion than said intersection between said first inclined portion and said end section while said engaging projecting portion and said engaging recess portion are arranged not to come into contact with each other on a side closer to said second end of said first inclined portion than said intersection between said first inclined portion and said end section in a state where said engaging projecting portion and said engaging recess portion engage with each other.

18. The electronic apparatus comprising a fixing structure for thin housings according to claim 16, wherein
either said engaging projecting portion or said engaging recess portion is provided with a second inclined portion inclined with respect to said engaging direction for facilitating engagement of said engaging projecting portion and said engaging recess portion, and
the electronic apparatus comprising a fixing structure for thin housings is so formed that the angle of inclination of said first inclined portion of said engaging surface of either said engaging projecting portion or said engaging recess portion is smaller than the angle of inclination of said second inclined portion.

19. The electronic apparatus comprising a fixing structure for thin housings according to claim 18, so formed that the width of said engaging surface of either said engaging projecting portion or said engaging recess portion in the extensional direction of said first inclined portion is larger than the width in the extensional direction of said second inclined portion.

20. The electronic apparatus comprising a fixing structure for thin housings according to claim 16, wherein
a clearance is formed between said second end of said first inclined portion and said end section of said engaging surface of either said engaging recess portion or said engaging projecting portion as viewed from said engaging direction in a state where said engaging projecting portion and said engaging recess portion engage with each other.
